(19) United States
(12) Patent Application Publication
(10) Pub. No.: US 2026/0180187 A1
(43) Pub. Date: Jun. 25, 2026

(54) OFF-BOARD ANTENNA

(71) Applicant: Insulet Corporation, Acton, MA (US)

(72) Inventors: Alexander Doudoumopoulos, Boxborough, MA (US); Colan Ryan, Escondido, CA (US); Lucas McGahren, Somerville, MA (US); Daniel Barrett, Somerville, MA (US); David Morris, Sterling, MA (US); Ian Quinn, Concord, MA (US); Nicholas Dennis, Sterling, MA (US)

(21) Appl. No.: 19/427,665

(22) Filed: Dec. 19, 2025

Related U.S. Application Data
(60) Provisional application No. 63/737,476, filed on Dec. 20, 2024.

(51) Int. Cl. H01Q 9/32; H01Q 1/22

(52) U.S. Cl. CPC H01Q 9/32; H01Q 1/22

(57) ABSTRACT

An automated medicament delivery device for automated administration of medicament to a user-body is disclosed. The automated medicament delivery device includes a delivery system, a printed circuit board (PCB), and an off-board antenna. The delivery system configured to deliver medicament to the user-body. The PCB comprising a PCB connection. The off-board antenna including an elevation portion. The elevation portion generally extends in a direction transverse to a plane defined by a surface of the PCB. The elevation portion includes a connection end in contact with the PCB connection electrically connecting the off-board antenna to the PCB. An upper portion secured to at least one support element chosen from a chassis and a housing of the automated medicament delivery device.

### CROSS-REFERENCE TO RELATED APPLICATIONS

This application claims the benefit under 35 U.S.C. § 119(e) of U.S. Provisional Patent Application Ser. No. 63/737,476, filed Dec. 20, 2024, the disclosure of which is hereby incorporated herein in its entirety by this reference.

### TECHNICAL FIELD

This disclosure relates generally to automated medicament administration. Some embodiments relate to an off-board Antenna for automated medicament delivery systems and devices.

### BACKGROUND

Automated medicament delivery devices (AMD, e.g., Automated Insulin Delivery (AID) device, without limitation) are often used to administer medicaments from a reservoir of the AMD to the body of a patient via a cannula inserted into the body to treat medical conditions (e.g., Type 1 Diabetes, without limitation).

The AMD often communicates with other devices, such an analyte sensor and a controller (e.g., a handheld electronic computing device, such as a mobile device or dedicated handheld controller).

Reliable communications between the AMD and other devices may be challenging, given the optimization of packaging space within the AMD and the fixed location of the AMD on a user-body during use. Current AMDs may use an antenna built into a printed circuit board assembly (PCBA) of the AMD. Performance of an antenna built into a PCBA may be limited by the proximity of the ground plane to the antenna and by the proximity of the antenna to the user-body. Both issues may result in a decrease in gain of the antenna, reducing the strength of the received signal when the antenna is communicating with other devices. If the gain and signal strength decrease too much, errors in communication between these devices may occur or a communication link may not be properly established.

A monopole is a commonly used antenna in wireless devices. However, manufacturing a monopole rising from a printed circuit board (PCB) may be cost prohibitive due to the connection required and the assembly process required to sort, dispense, and position the monopole to form the connection with the PCB.

### BRIEF SUMMARY

In one or more illustrative embodiments, an automated medicament delivery device for automated administration of medicament to a user-body includes a delivery system, a chassis, a housing, a PCB, and an off-board antenna. The delivery system is configured to deliver medicament to the user-body. The chassis is configured to support one or more components of the delivery system. The housing is configured to enclose multiple components therein. The PCB is within the housing and includes a PCB connection. The off-board antenna includes an elevation portion and an upper portion. The elevation portion generally extends in a direction transverse to a plane defined by a surface of the PCB. The elevation portion includes a connection end electrically connecting the off-board antenna to the PCB. The upper portion distal to the connection end secured to at least one support element chosen from among the chassis and the housing.

In one or more illustrative embodiments, an automated medicament delivery device for automated administration of medicament to a user-body includes a delivery system, a chassis, a housing, a PCB, and an off-board antenna. The delivery system is configured to deliver medicament to the user-body. The chassis is configured to support one or more components of the delivery system. The housing is configured to enclose multiple components therein. The PCB is within the housing and includes a PCB connection. The off-board antenna includes an elevation portion, an upper portion, and a connection end. The elevation portion generally extends in a direction transverse to a plane defined by a surface of the PCB. The upper portion connects to the elevation portion generally extending transverse to the elevation portion and offset from the PCB. The upper portion is secured to the chassis. The connection end is at an end of the elevation portion distal to the upper portion. The connection end electrically connecting the off-board antenna to the PCB.

In one or more illustrative embodiments, an automated medicament delivery device for automated administration of medicament to a user-body includes a housing, a PCB, and an off-board antenna. The housing is configured to enclose multiple components therein. The PCB is within the housing and includes a PCB connection. The off-board antenna includes an elevation portion, an upper portion, and a connection end. The elevation portion generally extending in a direction transverse to a plane defined by a surface of the PCB. The upper portion connected to the elevation portion generally extending transverse to the elevation portion and offset from the PCB. The upper portion secured to the housing. The connection end at an end of the elevation portion distal to the upper portion. The connection end electrically connecting the off-board antenna to the PCB.

In one or more illustrative embodiments, an automated medicament delivery device for automated administration of medicament to a user-body includes a delivery system, a PCB, and an off-board antenna. The delivery system configured to deliver medicament to the user-body. The PCB includes a PCB connection. The off-board antenna includes an elevation portion and a connection end. The elevation portion generally extends in a direction transverse to a plane defined by a surface of the PCB. The connection end is at an end of the elevation portion and includes windings that electrically connects the off-board antenna to the PCB connection, connecting the off-board antenna to the PCB.

In one or more illustrative embodiments, an off-board antenna for an automated medicament delivery device for automated administration of medicament to a user-body includes an elevation portion and a connection end. The elevation portion generally extending in a first direction. The connection end is at an end of the elevation portion and includes windings configured to electrically connect to a PCB connection of a PCB.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1 is a schematic diagram illustrating an automated medicament delivery device;

FIG. 2 is a block diagram of a medicament delivery system for controlled administering of medicament, in accordance with one or more embodiments;

FIG. 3 is a perspective view of a portion of an automated medicament delivery device, in accordance with one or more embodiments;

FIG. 4 is a side view of a portion of the automated medicament delivery device of FIG. 3;

FIG. 5 is a top view of a portion of the automated medicament delivery device of FIG. 3;

FIG. 6 is a perspective view of a portion of an automated medicament delivery device, in accordance with one or more embodiments;

FIG. 7 is a bottom perspective view of a cap of a housing of the automated medicament delivery device of FIG. 6 with an off-board antenna mounted thereto;

FIG. 8 is a perspective view of a portion of an automated medicament delivery device of FIG. 6;

FIG. 9 is a perspective view of a connection assembly of the automated medicament delivery device of FIG. 6;

FIG. 10 is a top view of the PCB of the automated medicament delivery device of FIG. 6;

FIG. 11 is a perspective view of a portion of an automated medicament delivery device, in accordance with one or more embodiments;

FIG. 12 is a performance graph illustrating a simulated result of an on-board PCB antenna;

FIG. 13 is a performance graph illustrating a simulated result of an off-board antenna in accordance with one or more embodiments;

FIG. 14 is a perspective view of a portion of an automated medicament delivery device, in accordance with one or more embodiments;

FIG. 15A is a perspective view of the PCB and the off-board antenna of the automated medicament delivery device of FIG. 14, in accordance with one or more embodiments;

FIG. 15B is a perspective view of the PCB and the off-board antenna of the automated medicament delivery device of FIG. 14, in accordance with one or more embodiments;

FIG. 16 is a perspective view of the off-board antenna of the automated medicament delivery device of FIG. 14, in accordance with one or more embodiments;

FIG. 17A a perspective view of the off-board antenna of the automated medicament delivery device of FIG. 14, in accordance with one or more embodiments;

FIG. 17B a side view of the off-board antenna of the automated medicament delivery device of FIG. 17A;

FIG. 18 is a perspective view of a portion of an embodiment of the automated medicament delivery device of FIG. 14;

FIG. 19 is a perspective view of a portion of an embodiment of the automated medicament delivery device of FIG. 14;

FIG. 20A is a perspective view of a portion of an embodiment of the automated medicament delivery device of FIG. 14, in accordance with one or more embodiments;

FIG. 20B is an exploded view of the portion of the automated medicament delivery device of FIG. 20A;

FIG. 20C is a perspective view of an antenna mount of a cap of the automated medicament delivery device of FIGS. 20A-20B, in accordance with one or more embodiments;

FIG. 20D is a perspective view of an antenna mount of FIG. 20C and a mounting post, in accordance with one or more embodiments;

FIG. 20E is a perspective view of an antenna mount of a cap of the automated medicament delivery device of FIGS. 20A-20B, in accordance with one or more embodiments; and

FIG. 21 is a parameter plot of simulated results including a primary antenna plot and a primary antenna with parasitic element plot.

### DETAILED DESCRIPTION

In various embodiments, an automated medicament delivery device (or system) includes an off-board antenna. As will be described in detail below, the off-board antenna may include an elevation portion generally extending in a direction transverse to a PCB of the automated delivery device and a connection end connecting the elevation portion to the PCB. The off-board antenna may also include an upper portion extending transverse to the elevation portion and offset from the PCB.

The illustrations presented herein are not actual views of any system, device, or structure, or any component thereof, but are merely idealized representations, which are employed to describe various embodiments.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any system, device, or structure, when utilized in a conventional manner. Furthermore, these terms may refer to an orientation of elements of any system, device, or structure, as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

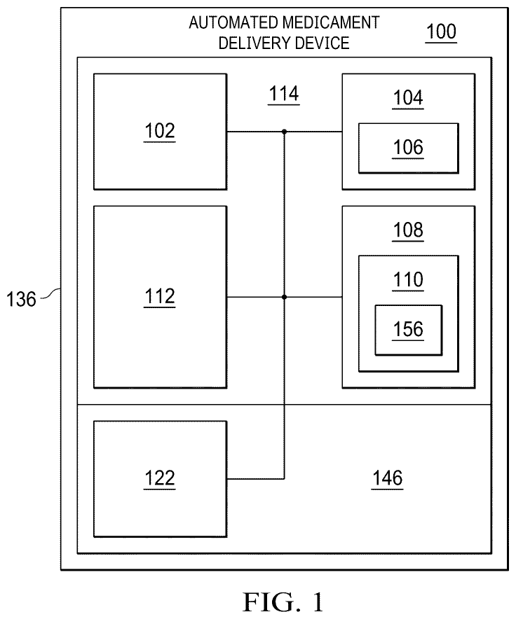

FIG. 1 is a schematic diagram illustrating an automated medicament delivery device (or system) 100 for automated administration of medicament to a user-body, in accordance with one or more embodiments.

In one or more embodiments, the automated medicament delivery device 100 may be capable of one or more operative modes of administration of medicament. Non-limiting examples of the one or more operative modes include fully automated administration of medicament, partially automated administration of medicament, or manual administration of medicament. In one or more embodiments, the automated medicament delivery device 100 may be capable of alternating between multiple (e.g., two or more, without limitation) operative modes. As a non-limiting example, the automated medicament delivery device 100 may alternate between one or more of: fully automated operation, partially automated operation, and manual operation.

The automated medicament delivery device 100 may administer medicament at least partially based on one or more values representative of amounts of one or more analytes present within a user-body (such values respectively an “analyte value”). The one or more analytes may include constituents of the user-body and foreign substances, such as medicaments, markers, metabolites, and combinations or subcombinations of one or more of the foregoing, without limitation. The automated medicament delivery device 100 may also administer an amount of medicament at least partially based on user inputs (e.g., a user defined bolus amount or details related to a meal consumed or about to be consumed, such as number of carbohydrates, amount of fat, and amount of protein, without limitation).

Non-limiting examples of medicaments administrable by the automated medicament delivery device 100 include: insulin, glucagon-like peptide-1 receptor agonist (GLP-1), glucose-dependent insulinotropic polypeptide (GIP), pramlintide, or other hormones, insulin substitutes, and combinations of medicaments, such as two or more of insulin, GLP-1, and GIP, or other like hormones. While specific examples discussed herein may involve insulin or GLP-1, or GIP, this disclosure is not limited to those examples, and other medicaments do not exceed the scope. As a non-limiting example, glucagon, morphine, analgesics, fertility medicaments, blood pressure medicaments, chemotherapy drugs, arthritis drugs, weight loss drugs, without limitation are non-limiting examples of medicaments that are specifically contemplated.

The automated medicament delivery device 100 is configured to administer medicament to a user-body, such as subcutaneously into the user-body, without limitation, in accordance with one or more embodiments. In one or more embodiments, the automated medicament delivery device 100 may offer one or more operative modes for administration of medicament to a user-body. When operating in some of the operative modes, automated medicament delivery device 100 may administer medicament at least partially responsive to analyte values, including without limitation analyte values received from an analyte sensor. The analyte sensor is configured to obtain data related to one or more analytes within the user-body (“analyte data”). The analyte sensor may be an analytical bio-sensing device, such as a continuous glucose monitor (CGM) or an integrated continuous glucose monitor (ICGM) (e.g., examples of commercially available analytical bio-sensing devices include the FREESTYLE LIBRE® 3 manufactured by Abbott or the DEXCOM® G6 manufactured by Dexcom, without limitation).

When operating in some further operative modes, automated medicament delivery device 100 may administer medicament at least partially responsive to user input. When operating some further operative modes, automated medicament delivery device 100 may administer medicament at least partially responsive to analyte values and user input. Non-limiting examples of the one or more operative modes offered by automated medicament delivery device 100 include: fully automated administration of medicament, partially automated administration of medicament, or manual administration of medicament. When operating in an operative mode that includes manual administration of medicament, automated medicament delivery device 100 may administer medicament solely in response to a user input (e.g., delivers medicament in response to a user confirmation of delivery of medicament or in response to a user instruction to deliver medicament, without limitation). When operating in an operative mode that includes fully automated administration of medicament, automated medicament delivery device 100 may administer medicament solely in response to analyte values (e.g., delivers medicament in response to one or more analyte values, without limitation). When operating in an operative mode that includes partially automated administration of medicament, automated medicament delivery device 100 may administer medicament in response to analyte values and user input (e.g., delivers medicament in response to a user input and an analyte value, or alternately delivers medicament in response to a user input or in response to analyte values, without limitation). Medicament administration may include administration of a basal amount of medicament regularly delivered a control interval (e.g., at a determined basal rate, without limitation) to keep analyte levels stable and within a determined or predetermined range. Medicament administration may also include administration of bolus amounts of medicament administered as an immediate bolus, an extended bolus, or a combination bolus (combination of an immediate bolus and an extended bolus). The bolus amount of medicament may be a correction bolus responsive to a change in analyte levels or a user defined bolus (e.g., responsive to user inputs provided, such as a user defined bolus amount or details related to a meal consumed or about to be consumed, such as number of carbohydrates, amount of fat, and amount of protein, without limitation).

The automated medicament delivery device 100 includes a delivery system 122, one or more processors 102, memory 104, communication equipment 108, a PCB 114, and a power source 112. The automated medicament delivery device 100 may also include a housing 136 configured to enclose the various components of the automated medicament delivery device 100 and a chassis 146 configured to hold or support one or more components (e.g., one or more components of the delivery system 122) of the automated medicament delivery device 100. In one or more embodiments, the automated medicament delivery device 100, or portions thereof, may be a wearable device and may be secured to a user-body (e.g., secured via one or more adhesive layers attaching the automated medicament delivery device 100 to the skin of the user-body or a material that is secured to the user body, without limitation). In various embodiments, the delivery system 122 is configured to cause an amount of medicament to move (e.g., flow, without limitation) toward and/or into a user-body.

In various embodiments, delivery system 122 may deliver amounts of medicament at least partially responsive to requests. In various embodiments, instructions 106 of memory 104 may include instructions for determining and generating requests for delivery system 122. In various embodiments, instructions 106 may include instructions for determining one or more amounts of medicament, determining a timing for delivery of one or more amounts of medicament, and for generating one or more requests for delivery system 122 related to the same. When such instructions of instructions 106 are executed by one or more processors 102, the one or more processors 102 determine the amounts of medicament and timing of delivery, generate requests for the delivery system 122 at least partially based on the determined amounts and timing, and provide the requests to delivery system 122.

The communication equipment 108 is configured to facilitate communication (e.g., wireless communication, without limitation) of the automated medicament delivery device 100 with other devices, including without limitation communication between the automated medicament delivery device 100 and the analyte sensor and/or a controller (e.g., a dedicated electronic device, a smart phone, a tablet computer, a wearable device, without limitation). The communication may be wired or wireless communication and may utilize any suitable communication protocol such as wireless networking protocol (e.g., Wi-Fi®, without limitation), a short-range wireless protocol (e.g., BLUETOOTH®, without limitation), a near-field communication standard, a cellular standard, or any other wireless optical or radio-frequency protocol. In various embodiments, the communication equipment 108 includes one or more antennas 110 for the wireless communication. The one or more antennas 110 include at least one off-board antenna 156. In various embodiments, the communication equipment 108 includes an Internet of Things (IOT) Subscriber Identity Module (SIM) card (e.g., a machine-to-machine SIM card, a Universal Integrated Circuit Card, without limitation).

The memory 104, one or more processors 102, and communication equipment 108 may be on and electrically connected via the PCB 114.

The power source 112 is configured to supply power to the delivery system 122 and the various electronic components, such as the one or more processors 102, memory 104, communication equipment 108, and the like. Power source 112 may be, as a non-limiting example, a power storage device (e.g., a battery, without limitation), a power inlet, a power regulator, or combination thereof.

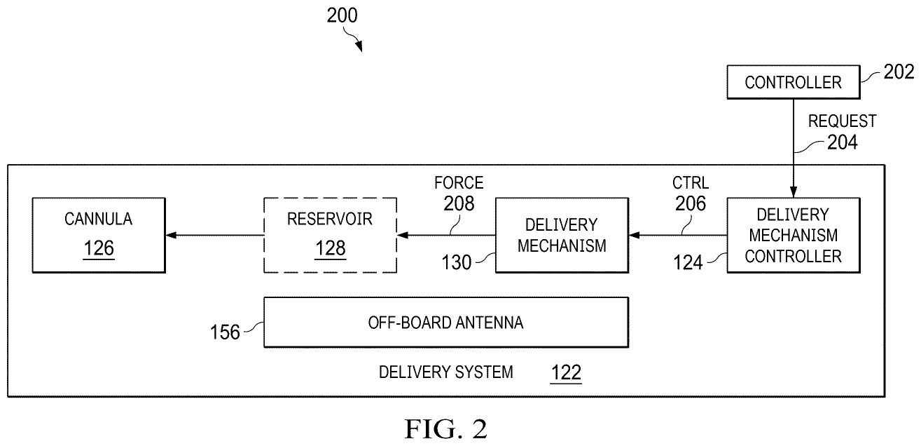

FIG. 2 is a block diagram of an automated medicament delivery system 200 for controlled administration of medicament to a user-body, in accordance with one or more embodiments. Automated medicament delivery system 200 includes a delivery system 122 and an integrated controller 202 (“controller 202”). Delivery system 122 includes delivery mechanism controller 124, delivery mechanism 130, cannula 126, and reservoir 128. The reservoir 128, which holds the medicament, may be configured as a permanent fixture within the device or as a replaceable component, as a non-limiting example based on user needs or medicament refill practices. In FIG. 2, the block representing the reservoir 128, which stores the medicament, is outlined in dashed lines to indicate its optional nature, either permanent or replaceable.

The controller 202 is configured to manage automated medicament delivery device 100 and, more generally, administration of medicament to a user-body. In one or more embodiments, controller 202 may be implemented by instructions 106 and one or more processors 102 of the automated medicament delivery device 100 of FIG. 1.

In various embodiments, controller 202 and delivery system 122 may be realized in different devices (e.g., controller 202 may be realized in a physically different device (or devices) than delivery system 122 is realized), or in the same device. When realized in different devices, functionality of controller 202 and delivery system 122 may be implemented, at least in part, by respective memory and one or more processors of their respective devices. When realized in a same device, functionality of controller 202 and delivery system 122 may be implemented, at least in part, by memory and one or more processors, respective memory and respective one or more processors, or a combination thereof. Non-limiting examples of devices in which controller 202, or a portion thereof, may be realized include: a handheld electronic computing device, such as a dedicated electronic device, a smart phone, a tablet computer, a wearable device (e.g., a smart watch, without limitation), a cloud computing device, and the like.

In various embodiments, the controller 202 may be configured to receive analyte data (e.g., from the analyte sensor, without limitation) including analyte values. In one or more embodiments, controller 202 may determine information about analytes within a user-body at least partially based on analyte data, for example, amounts, trends, distributions, without limitation. The controller 202 may analyze information about analytes in a user-body and may present the information and/or analysis to a patient, caregiver, or healthcare provider, as a non-limiting example, via an application (e.g., executing on a personal computer, smart phone, cloud server, or combinations thereof).

In various embodiments, the controller 202 may be configured to receive information from inputs from the patient or a caregiver (e.g., when the patient ate a meal or when the patient exercised, without limitation), and inputs from other electronic devices (e.g., information from a smartwatch, without limitation) and to utilize such information (e.g., process such information utilizing a control algorithm, without limitation) as discussed herein. For example, in various embodiments, controller 202 may utilize some or a totality of such information to determine amounts of medicament to administer and timing of administration of medicament. Further, controller 202 may also be configured to determine requests, including requests to administer dose 204, and send those requests to the automated medicament delivery device 100.

In various embodiments, controller 202 may be configured to determine a target dose amount to administer to a user of medicament delivery system 200. Controller 202 may determine a target dose amount at least partially based on one or more of therapy parameters, meal information, analyte values, and a control algorithm, without limitation.

In the context of insulin therapy to treat diabetes, therapy parameters may include insulin sensitivity factor (ISF), carbohydrate ratio (CR), amount of daily dose of long-acting insulin (LAI), doses of fast-acting or rapid-acting insulin, a current glucose value, and derivatives thereof without limitation. The timing and target dose amounts associated with requests generated by controller 202 may be governed by one or more control algorithms, discussed below.

Controller 202 may send a request to administer dose to delivery system 122, and more specifically, delivery mechanism controller 124.

The cannula 126 is insertable into a user-body (e.g., with a tip thereof positioned subcutaneously, without limitation) and is configured to provide medicament to a user-body (e.g., subcutaneously into the user-body, without limitation).

The reservoir 128 is configured to store and retain a medicament therein. As a non-limiting example, the reservoir 128 may be a hollow body, a flexible pouch, a chamber, a vial, without limitation. In various embodiments, reservoir 128 is a fluid reservoir for holding medicament and may be, as a non-limiting example, formed from the walls of a cartridge. In the cartridge example, delivery system 122 may include a chamber (i.e., a space or region defined within delivery system 122) configured to receive and hold a prefilled (prefilled with medicament) cartridge, eject an exhausted cartridge, and optionally receive a prefilled cartridge to replace (i.e., a replacement cartridge) the exhausted cartridge. Generally speaking, a volume of fluid in reservoir 128 will be greater in a pre-filled state than the volume in an exhausted state. Additionally or alternatively to the cartridge example, delivery system 122 is a multi-part delivery device where one of the two parts includes the reservoir 128 and the other one of the two parts includes the delivery mechanism controller 124. The other one of the two parts may optionally further include controller 202. Either one of the two parts may optionally include delivery mechanism 130 (e.g., a piston pump, without limitation). The one of the two parts that includes reservoir 128 is disposable (i.e., a “disposable part”) and configured to be removable secured to the other part of medicament delivery system 200. When reservoir 128 is exhausted, the disposable part may be removed and a replacement part including a reservoir 128 optionally in a pre-filled state.

Delivery mechanism 130 is configured to urge fluid in reservoir 128 toward an interface for dispensing fluid (interface not shown). In various embodiments, delivery mechanism 130 may be positioned adjacent to reservoir 128. The delivery mechanism 130 is configured to cause an amount of the medicament to be administered to the user-body by causing the amount to flow from the reservoir 128 toward and into a user-body via cannula 126, which is in fluidic communication with the reservoir 128. In various embodiments, delivery mechanism 130 may utilize any suitable mechanism to generate positive displacement or negative displacement to transfer amounts of medicament from reservoir 128 toward cannula 126 and a user-body.

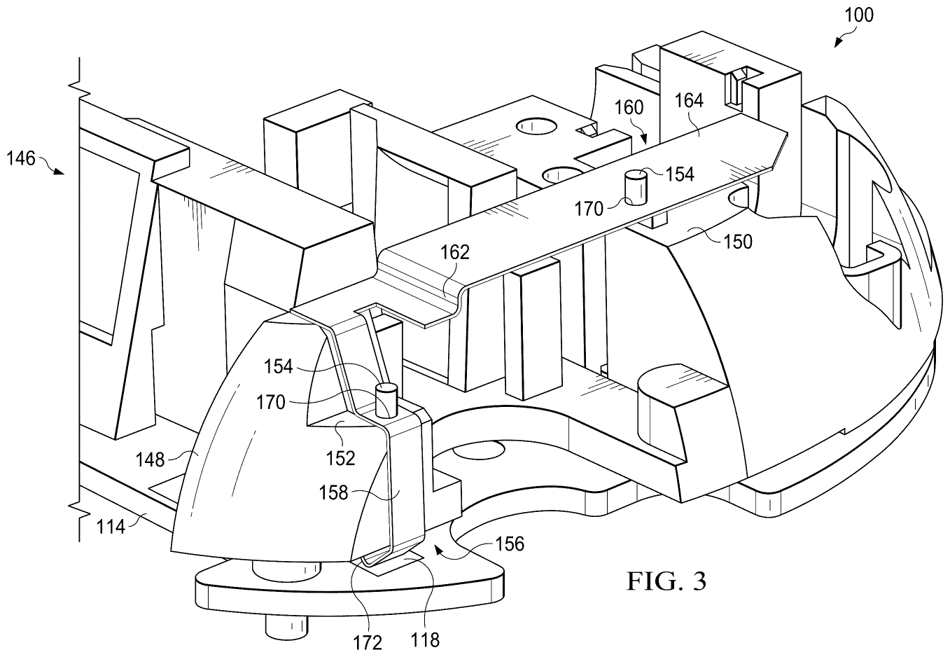

For example, delivery mechanism 130 may apply a force to a piston (or similar mechanisms, refer to FIGS. 3-8) free to move within reservoir 128, and via such a force, move the piston in a direction that urges fluid in reservoir 128 toward the aforementioned interface. In one or more embodiments, delivery mechanism 130 may include an electrical motor (e.g., an AC or DC motor) that produces a force to, directly or indirectly, move the piston to perform a delivery action. A delivery action dispenses at a predetermined rate (i.e., a predictable amount of fluid over a predictable duration of time). The delivery mechanism 130 may be capable of multiple rates of delivery, and in one or more embodiments, may be preconfigured to use the same rate of delivery all the time, or, in some cases, may be provided discretion to determine a rate of delivery consistent with a target dose amount included with a request.

Such an electric motor may be a current controlled electric motor, voltage controlled electric motor, pulse-width controlled electric motor, or combination or sub combination thereof. Such an electronic motor may be directly or indirectly digitally controlled. The control signal 206 may be determined and generated by delivery mechanism controller 124 to correspond to a delivery action. A control signal 206 may also be referred to herein as a “command 206” or an “instruction 206.”

Delivery mechanism controller 124 may generate control signals 206 corresponding to one or more delivery actions at least partially based on a request to administer dose 204 received from controller 202. Control signal 206 may include first control signals to cause delivery mechanism 130 to generate resultant force 208, and a second, different control signal( ) to cause drive delivery mechanism 130 to not or stop generating force 208. Utilizing control signals 206, delivery mechanism controller 124 may control a length of a duration of time that delivery mechanism 130 produces force 208 and applies it to dispense fluid from reservoir 128, and indirectly, an amount of fluid dispensed from reservoir 128.

When delivery mechanism controller 124 generates control signal 206 in response to a request to administer dose 204 from controller 202, it may generate the control signal 206 at least partially based on a value of a target dose amount included with, or indicated by, request to administer dose 204. One or more delivery actions may be utilized to dispense an amount fluid corresponding to a dose amount determined by controller 202. For example, a fluid amount dispensed according to a delivery action may be less than a dose amount. Generally speaking, the delivery mechanism 130, and delivery system 122, are agnostic to the purpose for which fluid is dispensed and unaware of what constitutes a working amount of fluid to administer a dose, or series of doses, of medicament. So, while it may be desirable that a fluid amount dispensed according to one or more delivery actions will be exactly the same as a target dose amount, some negligible difference is specifically contemplated, and what is considered “negligible” will depend on specific operation conditions.

In one or more embodiments, delivery mechanism controller 124 may be configured to determine and generate feedback information about delivery actions, such as times of delivery actions and dispensed amounts, without limitation. Feedback information may be generated based on information generated by delivery mechanism 130 or by sensors utilized by delivery mechanism controller 124 to monitor operation of delivery mechanism 130 (sensors not depicted). For example, sensors to monitor mechanical movement, current consumption, a voltage profile of an electric motor, without limitation. Such information may be logged and provided to and stored at controller 202, without limitation, for e.g., later processing or reading, without limitation. For example, the logs can be processed to determine patterns that may be utilized to determine whether delivery system 122 is operating as expected (e.g., in a predictable manner, without limitation), and, if a difference between actual and expected operation exceeds a threshold, delivery mechanism controller 124 may be updated (e.g., firmware, parameters, or both, of delivery mechanism controller 124 may be updated, without limitation) to compensate or correct for the difference. Additionally or alternatively to updating the firmware or parameters, in a multi-part system, one or more parts including delivery mechanism controller 124 or delivery mechanism controller 124 may be indicated as needing replacement (e.g., an alarm or alert is generated at delivery system 122, medicament delivery system 200, a mobile device or computer in communication therewith, without limitation).

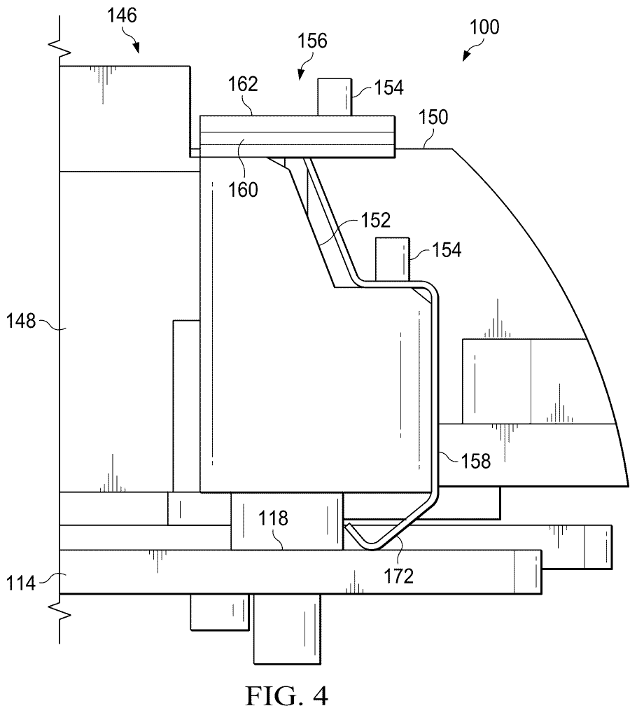

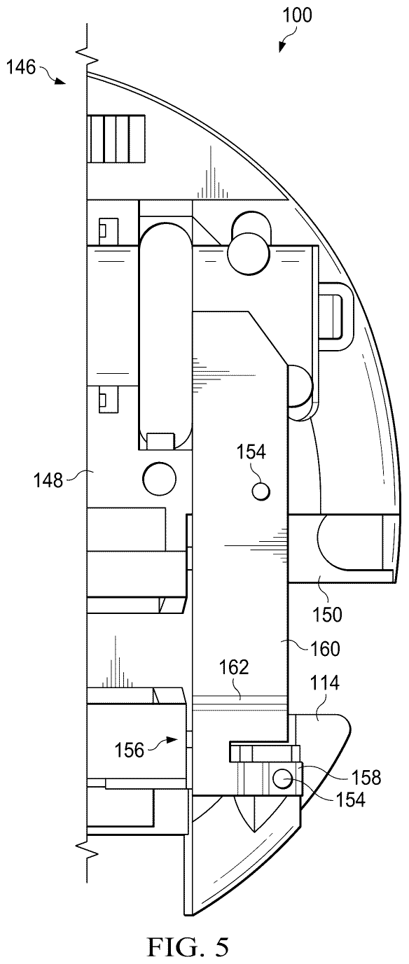

FIG. 3 is a perspective view of a portion of an automated medicament delivery device 100, in accordance with one or more embodiments. FIG. 4 is a side view of a portion of the automated medicament delivery device 100 of FIG. 3. FIG. 5 is a top view of a portion of the automated medicament delivery device 100 of FIG. 3. In the various embodiments disclosed herein, the automated medicament delivery device 100 includes an off-board antenna 156, mounted separate from the PCB 114 (i.e., not mechanically mounted or soldered directly to or on the PCB 114), that extends vertically from the PCB 114 (e.g., extending in a direction transverse to, such as substantially perpendicular to, a plane defined by a surface of the PCB 114, without limitation). Positioning an antenna off-board increases the distance between an antenna and a ground plane of a PCB and the user-body, which may improve communication performance using the limited space available within an automated medicament delivery device. An off-board antenna 156 may also reduce the amount of PCB area needed (thus saving material cost), as well as improving antenna reliability. Any variability in electrical properties during manufacture of PCBs may affect antenna performance. Off-board antenna 156 may be fabricated separately from the PCB 114, which may increase reliability of the off-board antenna 156 and may reduce susceptibility of the off-board antenna 156 to potential variability of properties of the substrate utilized for forming PCB 114, which may improve consistency in communication performance between automated medicament delivery devices 100 manufactured from one to the next.

In various embodiments, the off-board antenna 156 is mounted to at least one support element chosen from the chassis 146 and the housing 136 (e.g., a cap 138/top/upper section of the housing 136, without limitation) of the automated medicament delivery device 100. Although not mechanically mounted on the PCB 114, the off-board antenna 156 is electrically connectable to the PCB 114 via connectors or wires, to ensure proper signal transmission and reception. In the various embodiments of FIGS. 3-5, the off-board antenna 156 is configured to mount at least to the chassis 146. In various embodiments, the off-board antenna 156 includes a connection end 172 and an elevation portion 158. The connection end 172 electrically connects the off-board antenna 156 to the PCB 114. In the various embodiments of FIGS. 3-5, the connection end 172 includes a flexible connector, such as the spring finger connector (e.g., a flexible hook-shaped end, without limitation) of the specific non-limiting embodiment depicted by FIG. 3, that allows for flexibility and resilience, accommodating minor movements to ensure a reliable electrical connection between the off-board antenna 156 and the PCB connection 118. The connection end 172 may be positioned under a body 148 of the chassis 146, which placement may facilitate consistent contact between the connection end 172 and the PCB connection 118, even under varying conditions.

The elevation portion 158 generally extends vertically from the PCB 114 (e.g., extending in a direction transverse to a plane defined by a surface of the PCB 114, without limitation) and is configured to separate the upper portion 160 from the PCB 114 and connect the upper portion 160 to the PCB 114. The elevation portion 158 may include one or more portions that extends substantially perpendicular to a plane defined by a surface of the PCB 114, one or more portions that extends at an acute angle relative to the plane defined by the surface of the PCB 114, one or more portions that extends substantially parallel to the plane defined by the surface of the PCB 114, and any combination thereof. In various embodiments, the elevation portion 158 generally follows a contour 152 of the body 148 of the chassis 146.

In various embodiments, the off-board antenna 156 also includes an upper portion 160. The upper portion 160 is connected to the elevation portion 158 distal to the connection end 172 and generally extends transverse to the elevation portion 158, offset from the PCB. In various embodiments, the upper portion 160 extends across a top portion 150 of the chassis 146. In various embodiments, the upper portion 160 extends generally substantially parallel to the plane defined by the surface of the PCB 114. The upper portion 160 may include one or more steps 162 configured to align the sections of the upper portion 160 with corresponding sections of the top portion 150 of the chassis 146. A length of a peak portion 164 (which is a section of the off-board antenna 156 furthest from the PCB 114) of the upper portion 160 may be maximized (e.g., the peak portion 164 is longer than other sections of the off-board antenna 156, without limitation), which may improve performance of the off-board antenna 156. In various embodiments, the upper portion 160 includes a step 162 adjacent to a transition from the elevation portion 158 to the upper portion 160, the step 162 being adjacent to contact with an area of the top portion 150 that is lower than an area of the top portion 150 that contacts the peak portion 164 of the upper portion 160.

In various embodiments, the chassis 146 includes one or more posts 154 extending from the body 148 and the off-board antenna 156 includes one or more post openings 170. The one or more posts 154 may be heat stake posts. In some of the various embodiments, the chassis 146 includes at least two posts 154. In some of these various embodiments, the chassis 146 includes one post 154 that mates with a post opening 170 formed in the elevation portion 158 and one post 154 extending from the top portion 150 that receives a post opening 170 formed in the peak portion 164.

The one or more post openings 170 are configured to receive a respective post of the one or more posts 154. Mounting the off-board antenna 156 on the chassis 146 utilizing the one or more posts 154 and the one or more post openings 170 may simplify the assembly process of the automated medicament delivery device 100. Further, the one or more posts 154 may provide a consistent datum for achieving a reliable connection force between the connection end 172 and the PCB connection 118.

In various embodiments, the off-board antenna 156 is a singularly formed piece of sheet metal that is bent to define each portion thereof (e.g., the connection end 172, the elevation portion 158, and the upper portion 160, without limitation). In some of these various embodiments, the upper portion 160 includes a width greater than a width of the connection end 172 and of the elevation portion 158.

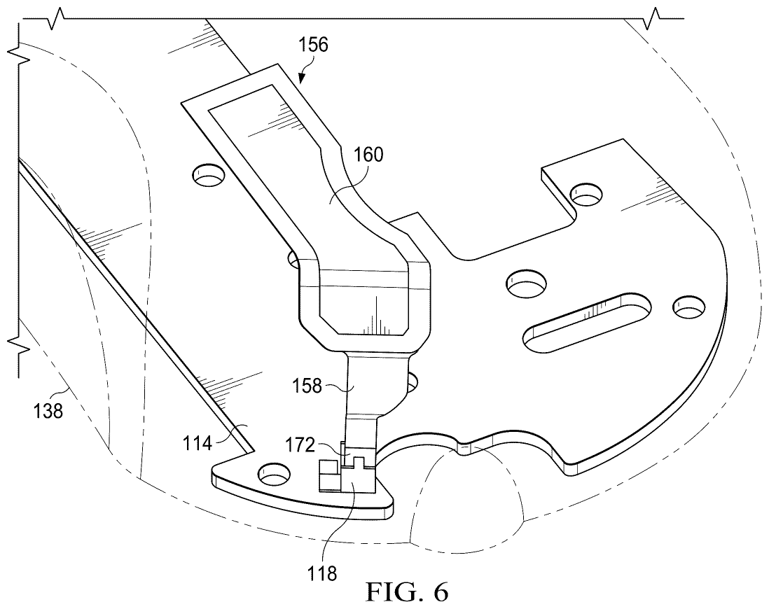

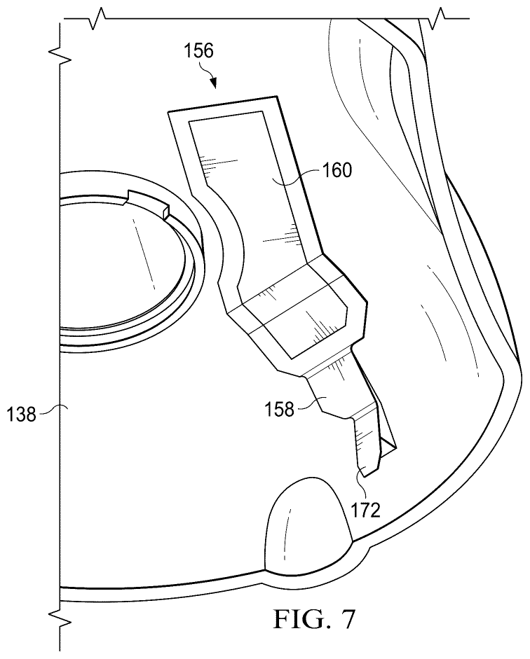

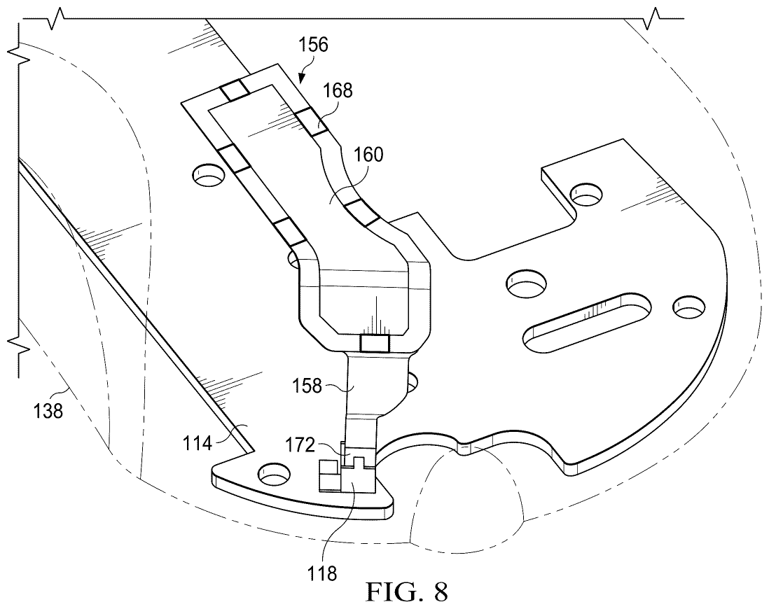

FIG. 6 is a perspective view of a portion of an automated medicament delivery device 100, in accordance with one or more embodiments. FIG. 7 is a bottom perspective view of the cap 138 of the automated medicament delivery device 100 of FIG. 6 with the off-board antenna 156 mounted thereto. FIG. 8 is a perspective view of a portion of the automated medicament delivery device 100 of FIG. 6. Referring to FIGS. 6-8, in various embodiments, the off-board antenna 156 is configured to mount to at least the cap 138 of the automated medicament delivery device 100.

In various embodiments, the upper portion 160 is secured to the cap 138 by one or more of standoffs 168 (e.g., heat stakes, adhesives, snap features, and other similar features, without limitation). The standoffs 168 may be integrally formed with the cap 138 and extend from an inner surface thereof or may be separately formed and joined to the inner surface of the cap 138. The standoff 168 act as mounting points for the off-board antenna 156.

Depending on the structure (e.g., the geometry and/or curvature) of the cap 138, and space inside the automated medicament delivery device 100, the number of bends in the off-board antenna 156, such as in the upper portion 160 and transitioning between the elevation portion 158 and the upper portion 160 may vary. In various embodiments, bends in the off-board antenna 156 are configured to maintain a proximity to an inside surface of the cap 138 within a predetermined amount. By minimizing a distance between an inside surface of the cap 138 and the off-board antenna 156, more space may be available for other components of the automated medicament delivery device 100 inside of the automated medicament delivery device 100. Further, the closer the upper portion 160 is to the inside of the cap 138, the greater distance the upper portion 160 is away from the PCB 114 and off of the user-body, which may improve performance of the off-board antenna 156.

In various embodiments, the standoffs 168 are connected to the off-board antenna 156 and are configured to be received in depressions (e.g., blind holes, without limitation) formed in the cap 138, the depressions configured to receive the standoffs 168 in an interference condition, such as with snap features (e.g., protrusions and indentations configured to receive the protrusions, without limitation). The standoffs 168 may function as heat stakes, for example, if there are cutouts in the off-board antenna 156 or overhang after the off-board antenna 156 is secured thereto.

The off-board antenna 156 may be secured to the cap 138 prior to the cap 138 being assembled with other components of the automated medicament delivery device 100, which may simplify assembly of the automated medicament delivery device 100.

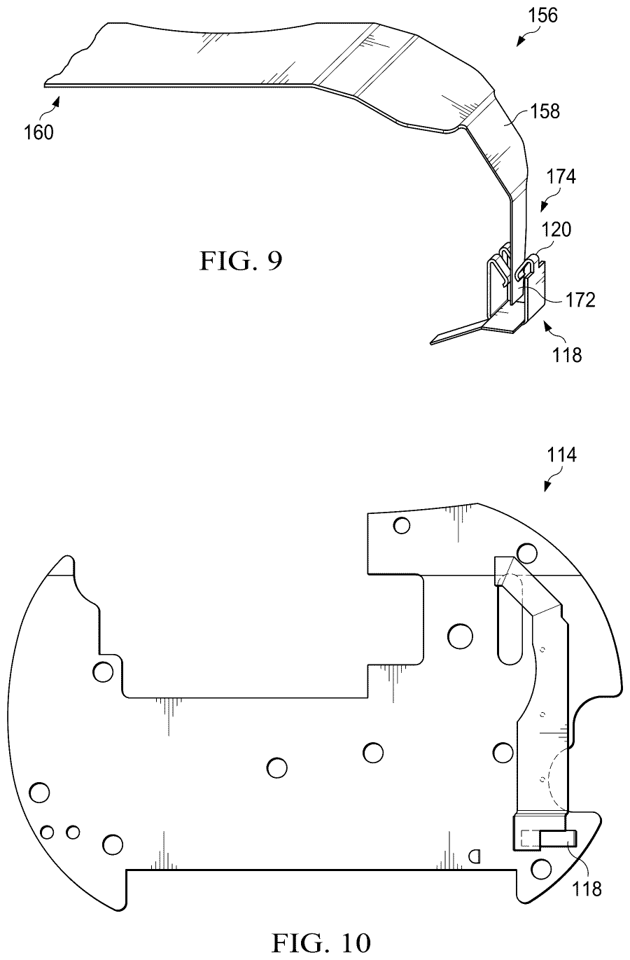

FIG. 9 is a perspective view of a connection assembly 174 of the automated medicament delivery device 100 of FIG. 6. In various embodiments, the connection assembly 174 includes a PCB connection 118 configured to be joined to the PCB 114 and a connection end 172 of the elevation portion 158 of the off-board antenna 156. The connection end 172 may be the distal end of the elevation portion 158 relative to the upper portion 160.

In various embodiments, the PCB connection 118 includes a blade and tulip connector. In these various embodiments, the PCB connection 118 includes fingers 120 configured to receive the connection end 172, the connection end 172 including a blade-like shape. During assembly, when the cap 138 is placed onto an assembly of the bottom of the housing 136, chassis 146, and PCB 114, the connection formed by the connection assembly 174 may be made prior to sealing the automated medicament delivery device 100, and in particular, prior to sealing the cap 138 to the bottom of the housing 136. This arrangement may allow for loose tolerances between the connection end 172 of the off-board antenna 156 and the PCB connection 118 in a Z dimension (e.g., a direction perpendicular to the PCB 114) as the fingers 120 can grab onto the connection end 172 at multiple heights depending on the stack up in the automated medicament delivery device 100.

As noted above, in various embodiments, the off-board antenna 156 is secured to the cap 138 prior to assembly of the cap 138 to a bottom of the housing 136. The blade and tulip connector may facilitate forming the connection between the off-board antenna 156 and the PCB 114 during assembly of the housing 136.

In various embodiments, the off-board antenna 156 may be secured to the cap 138 and secured to the top portion 150 of the chassis 146. Any PCB connection 118 disclosed herein may be utilized to form the connection between the off-board antenna 156 and the PCB 114 for any of the embodiments of the off-board antenna 156 disclosed herein, whether the off-board antenna 156 is secured to the cap 138, the top portion 150 of the chassis 146, or to both.

FIG. 10 is a top view of the printed circuit board (PCB) of the automated medicament delivery device 100 of FIG. 6. This illustration highlights the layout and placement of various electronic components on the PCB 114. FIG. 10 depicts the connection point, where the flexible connector (e.g., connection end 172) of the off-board antenna 156 establishes a reliable electrical connection with PCB connection 118.

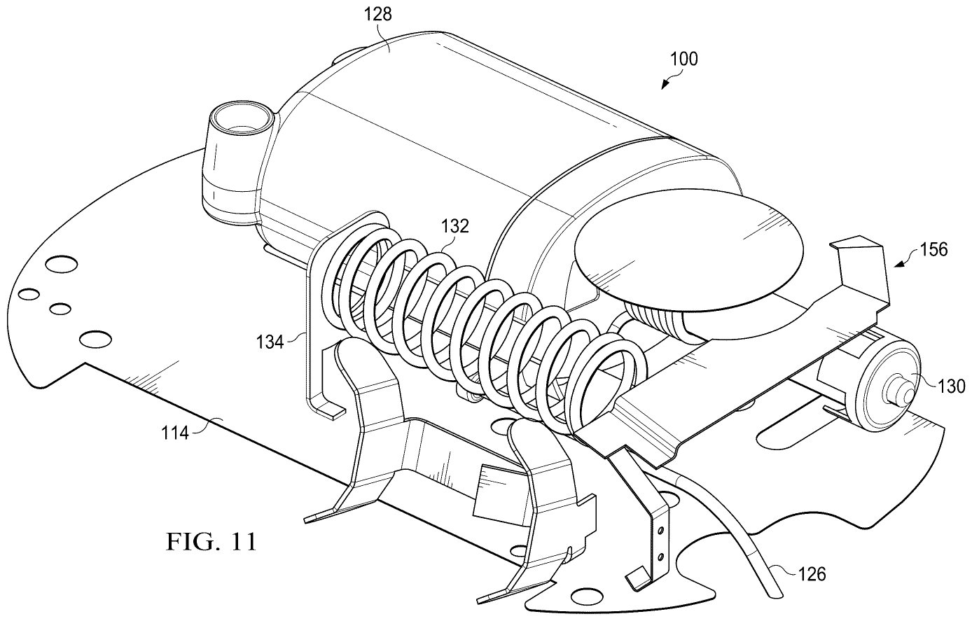

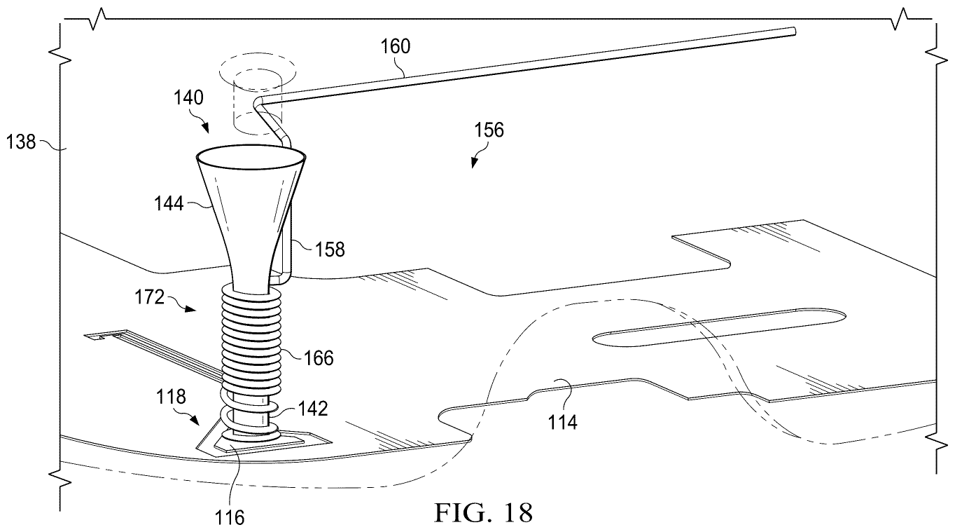

FIG. 11 is a perspective view of a portion of the automated medicament delivery device 100 of FIG. 6, in accordance with one or more embodiments. In various embodiments, various components of the automated medicament delivery device 100 are utilized as part of an overall antenna system. A shape of a ground plane of the PCB 114 may be configured to improve polarization purity of the off-board antenna 156. The shape of the ground plane may influence which direction that current may flow. For example, a narrow rectangular ground plane (refer to FIG. 10) may result in current flowing primarily horizontally, producing primarily a horizontal polarization of the radiated power, while an L-shaped ground plane (refer to FIG. 18) may permit current to flow both horizontally and vertically, producing both horizontal and vertical polarizations, without limitation. Various components of the automated medicament delivery device 100 may be electrically connected via an electrical contact 134 to the ground of the off-board antenna 156, components such as a spring 132, the reservoir 128, and the like.

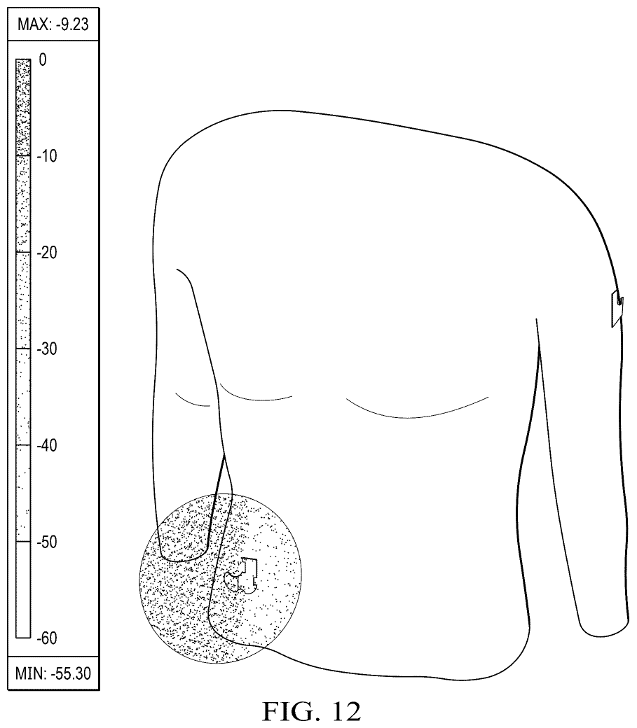

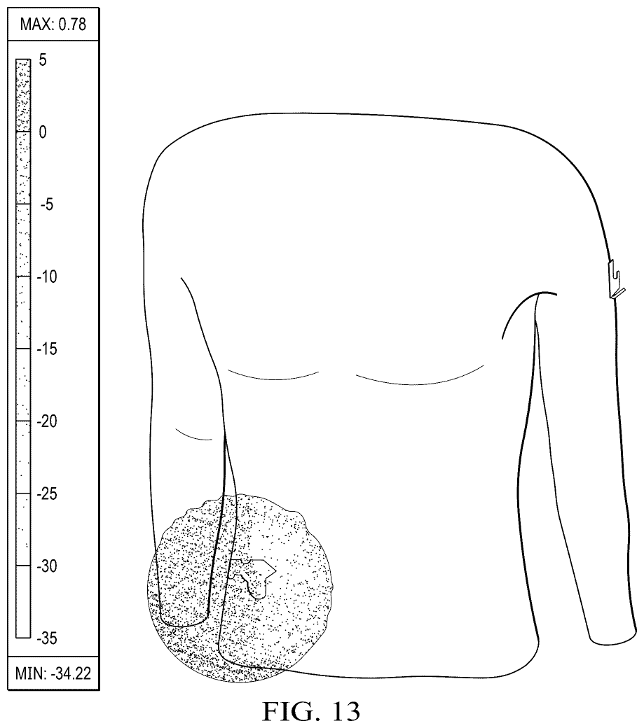

FIG. 12 is a performance graph illustrating a simulated result of an on-board PCB antenna used in an automated medicament delivery device. FIG. 13 is a performance graph illustrating a simulated result of an off-board antenna in accordance with one or more embodiments. As illustrated in FIGS. 12 and 13, an automated medicament delivery device 100 with an antenna off-board, such as off-board antenna 156, may reduce interference with the off-board antenna 156 from other components in the automated medicament delivery device 100 (e.g., the batteries, needle springs, and the chassis, without limitation) and may increase efficiency of the off-board antenna 156 as the separation between the off-board antenna 156 and the user-body increases. An antenna printed on a PCB may be at least partially overlapped by other components, which may impair performance, may reduce a range of the antenna, and may reduce the battery life (if the transmit power is increased to compensate for the impairment). Placing the antenna off-board may allow the antenna to be positioned above the various other components of the automated medicament delivery device 100 and further from the user-body, which may reduce interference.

The performance graphs of FIGS. 12 and 13 illustrate some of the potential benefits of using an off-board antenna compared to a PCB trace antenna. In FIGS. 12 and 13, both types of antennas are simulated on a human body model; the resulting gain of the PCB antenna is approximately −9dB, while the gain of the off-board antenna is 0.78 dB. This 10 dB difference is equivalent to increasing the effective range of the antenna by a factor of three. Or, to maintain the same range, the power of the off-board antenna can be reduced by 10 dB (a factor of 10) compared to the PCB version. The performance graphs provided in FIGS. 12 and 13 are based on simulated results intended to illustrate potential performance characteristics of an on-board PCB antenna within an automated medicament delivery device and an off-board PCB antenna within the automated medicament delivery device. Actual performance or performance improvements may vary based on various factors such as manufacturing tolerances, environmental and operating conditions, and specific use cases, without limitation. These performance graphs are not intended to convey any specific performance requirement or guarantee. They serve as comparative tools to highlight the potential benefits of different design choices, such as an on-board PCB antenna design versus the off-board antenna design discussed herein.

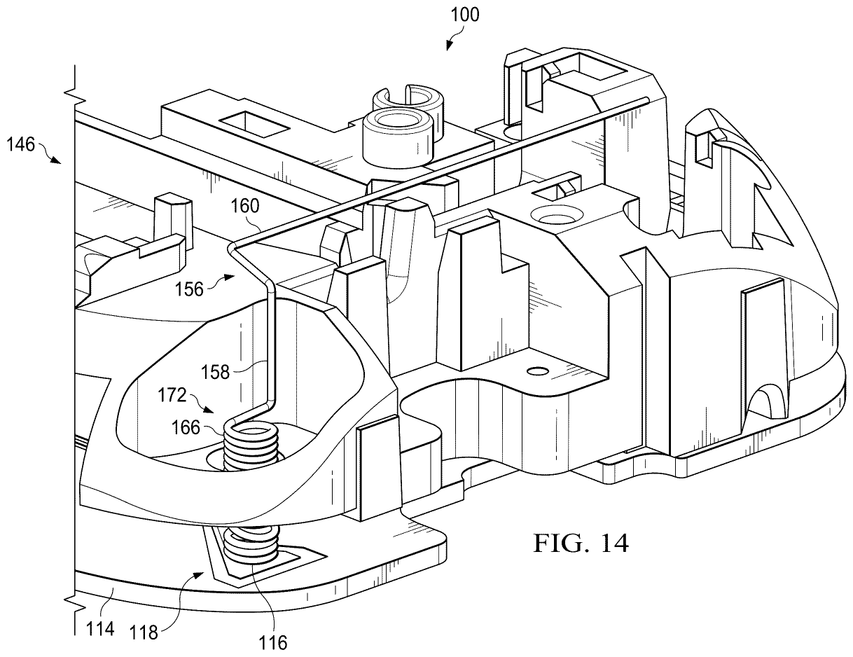

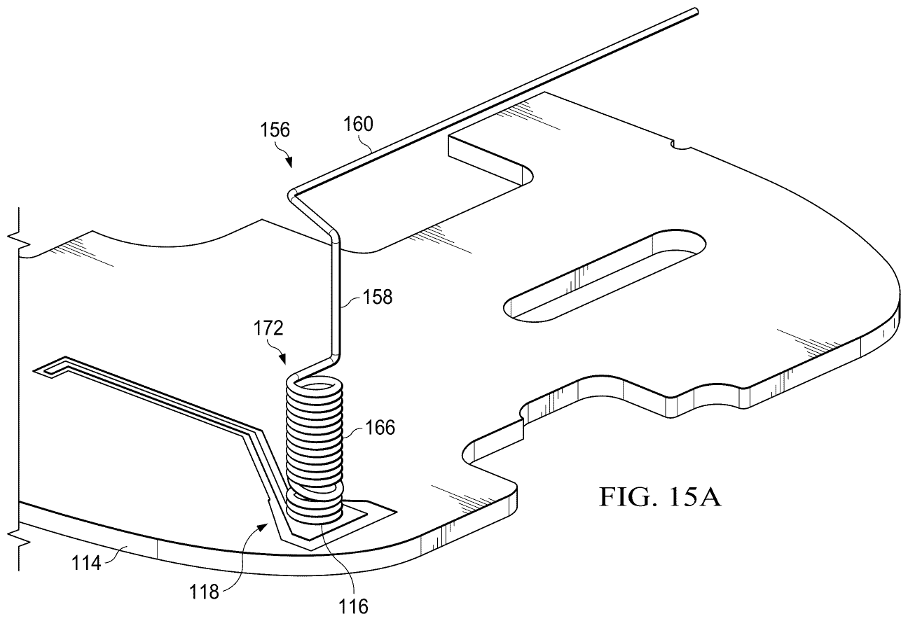

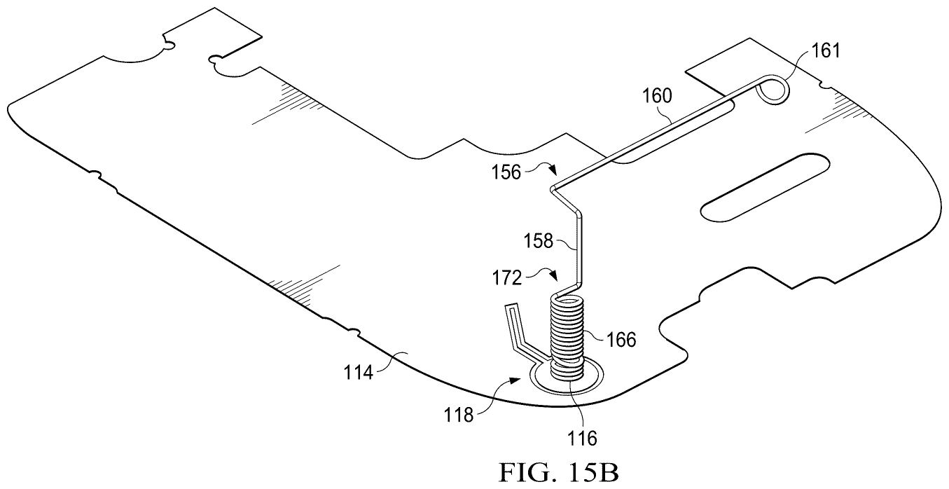

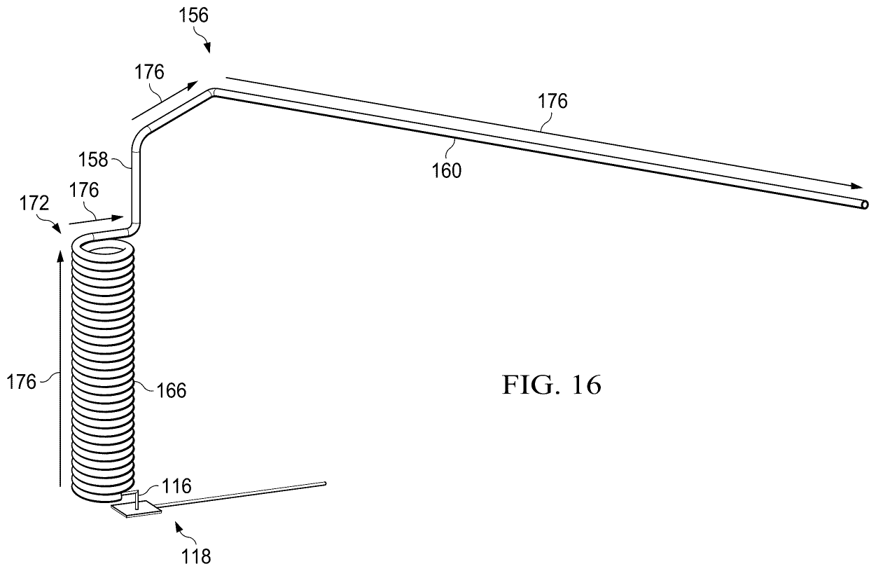

FIG. 14 is a perspective view of a portion of an automated medicament delivery device 100, in accordance with one or more embodiments. FIG. 15A is a perspective view of the PCB 114 and the off-board antenna 156 of the automated medicament delivery device 100 of FIG. 14, in accordance with one or more embodiments. FIG. 15B is a perspective view of the PCB 114 and the off-board antenna 156 of the automated medicament delivery device 100 of FIG. 14, in accordance with one or more embodiments. FIG. 16 is a perspective view of the off-board antenna 156 of the automated medicament delivery device 100 of FIG. 14, in accordance with one or more embodiments. Referring to FIGS. 14-16, in various embodiments, the off-board antenna 156 includes a monopole. The monopole may be bent to facilitate the use thereof within the automated medicament delivery device 100. In other various embodiments, the off-board antenna 156 may be another type of antenna (e.g., a patch antenna, without limitation). Similar to other embodiments disclosed herein, in various embodiments, the off-board antenna 156 includes a connection end 172, an elevation portion 158, and an upper portion 160. The connection end 172 electrically connects the off-board antenna 156 to the PCB 114 at a PCB connection 118. As can be seen in FIGS. 15A and 15B, the PCB connection 118 may include a landing pad with a contact area (e.g., a circular area, a triangular area, a rectangular area, without limitation). The contact area may be sized and shaped to improve alignment tolerance (e.g., a circular area may improve tolerances of a connection with the connection end 172).

In the various embodiments of FIGS. 14-16, the connection end 172 includes windings 166 that electrically connect the off-board antenna 156 to the PCB connection 118. The contact point 116 between the windings 166 and the PCB connection 118 may be spread out over a majority of an end coil of the windings 166, increasing a surface area of contact between the off-board antenna 156 and the PCB connection 118 that forms a wider contact point 116, which may improve a connection therebetween. The connection end 172 may extend through an opening formed in the body 148 of the chassis 146. The windings 166 may at least partially extend through the opening formed in the body 148. The windings 166 may include a spring configuration.

The windings 166 are configured to compress with at least a majority of the coils in contact with adjacent coils while within an assembled automated medicament delivery device 100. In various embodiments, about a full length of each of the majority of the coils is in contact with the adjacent coils. In various embodiments, substantially all of the coils are in contact with adjacent coils while in an assembled state (e.g., assembled within an automated medicament delivery device 100, without limitation). As illustrated in FIG. 16, with the coils in contact with adjacent coils, a direction of the current 176 traveling through the off-board antenna 156 may pass straight through the windings 166 (e.g., vertically) rather than flowing around and through each coil individually, which may prevent the windings 166 from functioning as an inductor, from generating electromagnetic fields that may interfere with the signal strength, which may reduce the efficiency of the antenna and the effective communication range. Forming an electrical connection between the off-board antenna 156 and the PCB 114 with compressible windings may ensure a consistent and reliable electrical connection without the use of special connectors or solder points.

The connection end 172 including windings 166 may be utilized for forming a connection between the PCB 114 and the off-board antenna 156 with any of the embodiments of the off-board antenna 156 disclosed herein.

The elevation portion 158 generally extends vertically from the PCB 114 (e.g., extending in a direction transverse to a plane defined by a surface of the PCB 114, without limitation) and is configured to separate the upper portion 160 from the PCB 114 and connect the upper portion 160 to the PCB 114. The elevation portion 158 may include one or more portions that extends substantially perpendicular to a plane defined by a surface of the PCB 114, one or more portions that extends at an acute angle relative to the plane defined by the surface of the PCB 114, one or more portions that extends substantially parallel to the plane defined by the surface of the PCB 114, and any combination thereof. In various embodiments, the elevation portion 158 generally follows a contour 152 of the body 148 of the chassis 146.

In various embodiments, the upper portion 160 includes a loop 161 at an end of the upper portion 160 distal to the elevation portion 158. The loop 161 may include a diameter that is about (e.g., within a predetermined tolerance or within a 5 percent difference, without limitation) the same diameter of the as the windings 166. In various embodiments, the diameter of the loop 161 is sufficient to prevent a straight section of the upper portion 160 from entering the cylindrical coil section of another off-board antenna 156 (e.g., during storage of multiple off-board antennas 156, transport of multiple off-board antennas 156, or during an assembly process, without limitation).

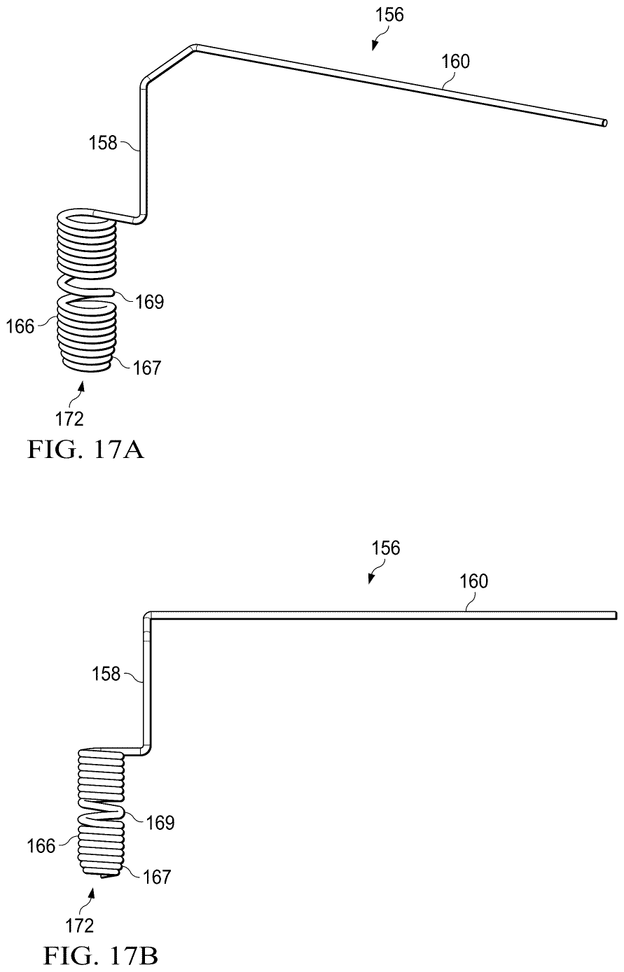

FIG. 17A a perspective view of the off-board antenna 156 of the automated medicament delivery device 100 of FIG. 14, in accordance with one or more embodiments. 17B a side view of the off-board antenna 156 of the automated medicament delivery device 100 of FIG. 17A. Referring to FIGS. 17A and 17B, in various embodiments, an end of the windings 166 includes a tapered portion 167 distal to the elevation portion 158. The tapered portion 167 may be at the connection end 172 and may be positioned to contact and form the connection with the PCB connection 118.

In various embodiments, the windings 166, prior to assembly within the automated medicament delivery device 100 may include an open coil section 169. The open coil section 169 may be positioned at any part of the windings 166 (e.g., a bottom of the windings 166, as illustrated in FIGS. 15A and 15B, a middle of the windings 166, as illustrated in FIGS. 17A and 17B, or a top of the windings, without limitation). The open coil section 169 is configured to compress during assembly of the automated medicament delivery device 100. The adjacent coils of the windings 166 at the open coil section 169 move closer together and may partially, substantially, or fully come into contact upon compression. The amount of contact between adjacent coils of the windings 166 at the open coil section 169 may depend on tolerances of the assembly, but in a preferred embodiment, adjacent coils at the coil section 169 are touching after having been compressed upon assembly of the automated medicament delivery device 100.

FIG. 18 is a perspective view of a portion of an embodiment of the automated medicament delivery device 100 of FIG. 14. In various embodiments, a post 140 is configured to compress the windings 166 to ensure contact between adjacent coils and to form a reliable electrical contact between the windings 166 and the PCB connection 118. The post 140 may include a rod 142 and a compression portion 144. The rod 142 is configured to extend at least partially into the windings 166, and may extend through the windings 166 (e.g., about a one-third to two thirds of the windings 166 or about half of the windings 166, without limitation). The rod 142 may guide positioning of the off-board antenna 156, and in particular, the windings 166, to align the off-board antenna 156 relative to the PCB 114 and the PCB connection 118. The compression portion 144 is configured to compress coils of the windings 166 into the PCB 114 (e.g., between the compression portion 144 and the PCB 114, without limitation) to bias the windings 166, and in particular, an end coil, towards the PCB connection 118 to maintain the contact point 116 therebetween.

In various embodiments, the rod 142 includes a cylindrical shape (e.g., a right circular cylinder, without limitation) with an outer diameter smaller than an inner diameter of the coils of the windings 166, and the compression portion 144 includes a frustoconical shape that tapers from a first diameter less than the inner diameter of the coils at a connection with the rod 142 to a second diameter that is larger than the coils.

The post 140 may be integrally formed with the cap 138 as a unitary structure or may be separately formed and joined to the cap 138. In various embodiments, the post 140 is formed of a non-conductive material (e.g., a same material as the cap 138, without limitation).

The off-board antenna 156 may be fixed to the cap 138 prior to assembly of the cap 138 to the bottom of the housing 136 and the contact between the windings 166 and the PCB connection 118 is made during assembly of the housing 136. In various embodiments, the off-board antenna 156 is fixed to the cap 138 via a press fit into channels formed therein.

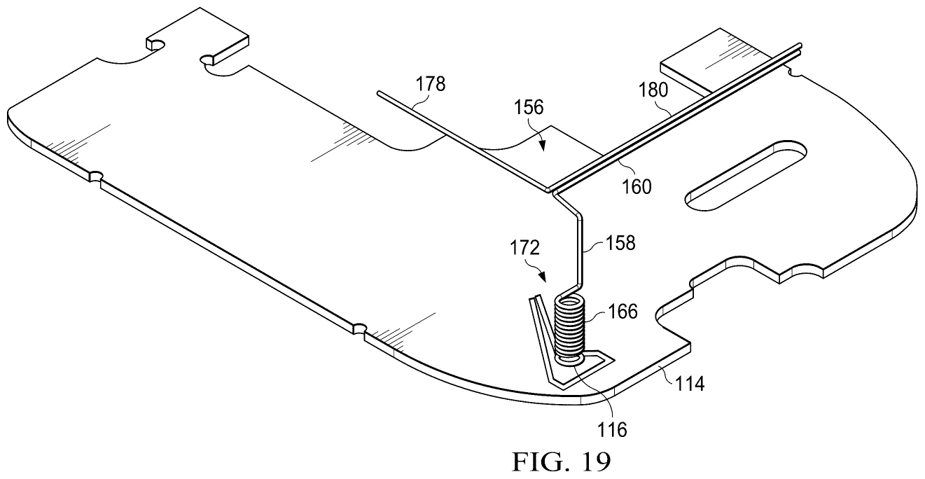

FIG. 19 is a perspective view of a portion of an embodiment of the automated medicament delivery device 100 of FIG. 14. In various embodiments, the off-board antenna 156 includes a parasitic element 178 and a primary antenna comprising the connection end 172, the elevation portion 158, and the upper portion 160 (which are an integral component) parasitic element 178 physically separated from the primary antenna (i.e., contactless/not connected to the primary antenna). The parasitic element 178 is also physically separated from the PCB 114 (i.e., contactless/not connected to the PCB 114). The parasitic element 178 is configured to function as a second resonator. In particular, the parasitic element 178 is configured to couple electromagnetically to the primary antenna, resulting in another resonance, which may increase the impedance bandwidth of the off-board antenna 156.

A shape of the parasitic element 178 may be arranged as needed to fit within the housing while being physically separated from both the primary antenna and the PCB 114. The parasitic element 178 may include one or more bends. In various embodiments, the parasitic element 178 includes a wire. The wire may have an L shape. The parasitic element 178 may be oriented in a plane substantially parallel to a plane defined by a surface of the PCB 114. In various embodiments, the parasitic element 178 includes a segment 180 positioned substantially parallel to the upper portion 160 and near the upper portion 160 (i.e., next to and contactless from the upper portion 160 while being close enough to the upper portion 160 to electromagnetically couple to the primary antenna).

In various embodiments, a total length of the parasitic element 178 is substantially similar to a total length of the primary antenna including a length of the compressed windings 166, while in an installed condition (e.g., installed in the automated medicament delivery device 100, such as positioned within the housing 136, without limitation), rather than a wire length of each of the coils. In various embodiments, a total length of the parasitic element 178 is significantly different (e.g., at least less than a quarter of the length, at least less than half the length, at least one and one-half the length, at least twice the length, without limitation) than a total length of the primary antenna including a length of the compressed windings 166, while in an installed condition (e.g., installed in the automated medicament delivery device 100, such as positioned within the housing 136, without limitation), rather than a wire length of each of the coils.

The parasitic element 178 may be fixed to the cap 138 prior to assembly of the cap 138 to the bottom of the housing 136. In various embodiments, the parasitic element 178 is fixed to the cap 138 via a press fit into channels formed therein.

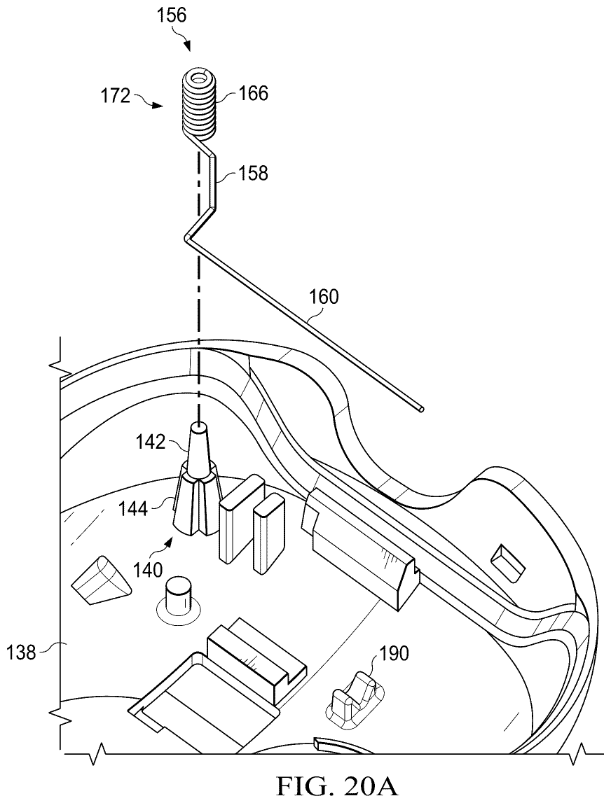

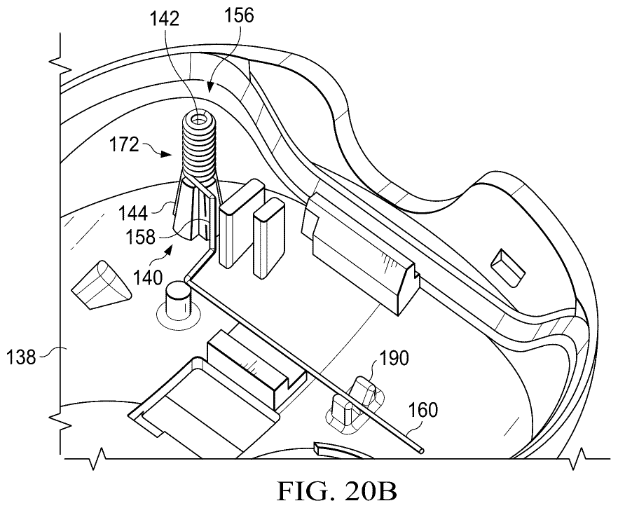

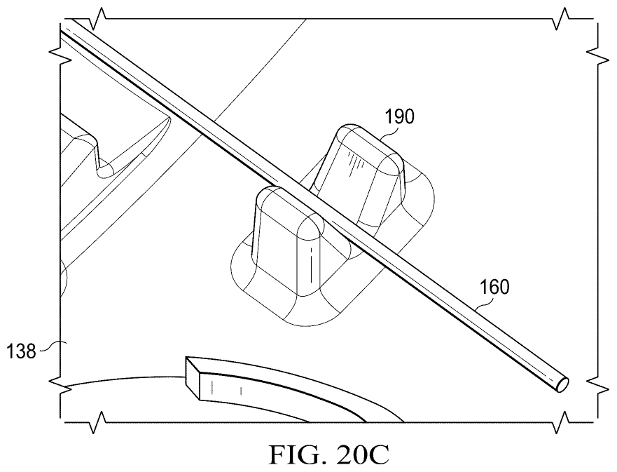

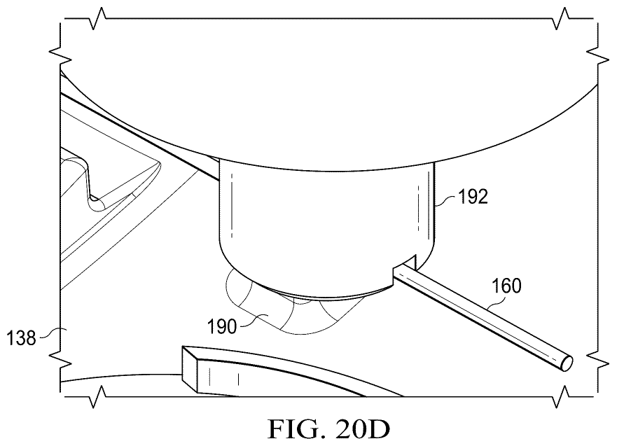

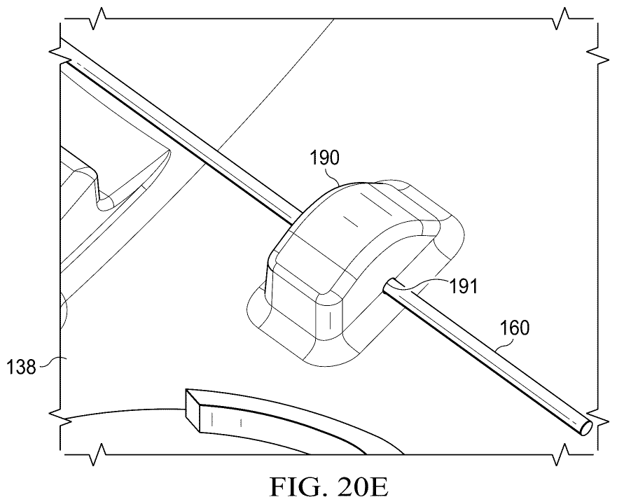

FIG. 20A is a perspective view of a portion of an embodiment of the automated medicament delivery device 100 of FIG. 14, in accordance with one or more embodiments. 20B is an exploded view of the portion of the automated medicament delivery device 100 of FIG. 20A. FIG. 20C is a perspective view of an antenna mount 190 of a cap 138 of the automated medicament delivery device 100 of FIGS. 20A-20B, in accordance with one or more embodiments. FIG. 20D is a perspective view of an antenna mount 190 of FIG. 20C and a mounting post, in accordance with one or more embodiments. FIG. 20E is a perspective view of an antenna mount 190 of a cap 138 of the automated medicament delivery device 100 of FIGS. 20A-20B, in accordance with one or more embodiments. Referring to FIGS. 20-20E, in various embodiments, the cap 138 includes an antenna mount 190 protruding from an inner surface thereof. As can be seen in FIG. 20E, the antenna mount 190 receives a part of the upper portion 160 of the off-board antenna 156 and is supported thereby. In various embodiments, the antenna mount 190 includes a heat stake.

In various embodiments, an inner diameter of the windings 166 and an outer surface of the rod 142 are sized to define a press-fit therebetween.

FIGS. 20A-20E illustrate a method of securing the off-board antenna 156 to the cap 138. Referring to FIGS. 20A and 20B, in various embodiments, the method includes positioning at least a portion of the windings 166 over the rod 142 with an end of the windings 166 adjacent to the elevation portion 158/distal to a contact portion of the winding 166 (e.g., distal to the tapered portion 167) adjacent to the compression portion 144. The windings 166 may contact the compression portion 144.

The method also includes positioning a part of the upper portion 160 of the off-board antenna 156 within an antenna mount 190. Referring to FIGS. 20C-20E, positioning a part of the upper portion 160 of the off-board antenna 156 within an antenna mount 190 may include positioning the part of the upper portion 160 within a heat-stake V-block that initially defines the antenna mount 190 protruding from the cap 138 and melting the heat-stake V-block with a heat stake machine 192, which melts the materials of the heat-stake V-block and forms the antenna mount 190 around the part of the upper portion 160, the upper portion 160 held within a through hole 191 formed therein.

The windings 166 may be compressed upon assembly of the cap 138 to a remainder of the housing 136.

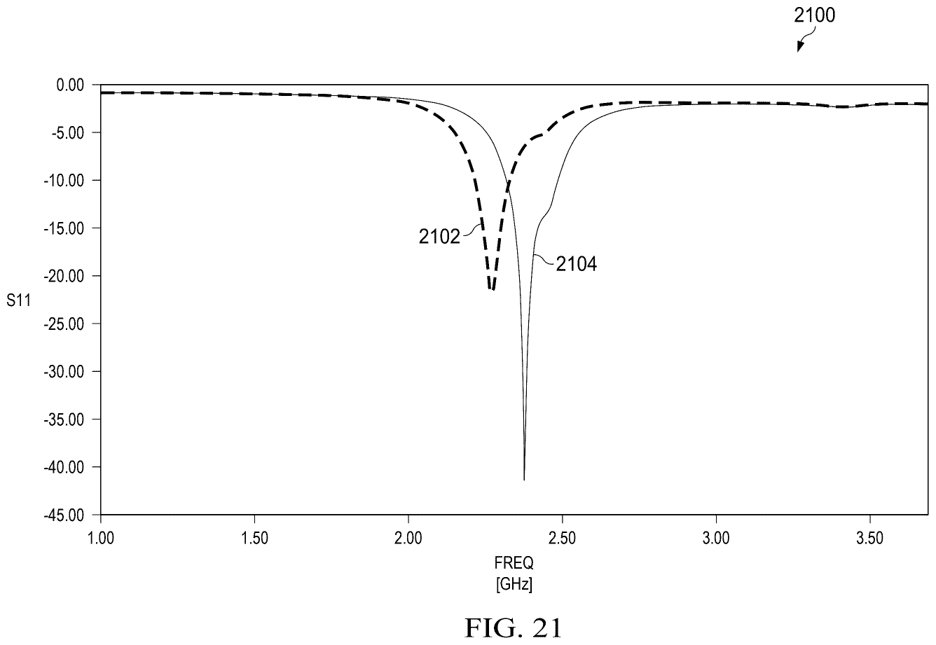

FIG. 21 is a parameter plot 1900 of simulated results including a primary antenna plot 1902 and a primary antenna with parasitic element plot 1904. Increasing the impedance bandwidth (the range of frequencies over which an antenna's reflection coefficient (S₁₁) is less than −10 dB) is desirable in general since the antenna may be detuned by variances in manufacturing or by elements in the user's environment. As illustrated in FIG. 19, the impedance bandwidth of a primary antenna may increase by adding a parasitic element. In particular, the simulated results of FIG. 21 illustrate that the addition of a parasitic element may increase the bandwidth of the primary antenna by almost 50 %, up to 170 MHz where the primary antenna without the parasitic element had a bandwidth of 110 MHz.

As both the primary antenna and the parasitic element are off-board, the various embodiments including a parasitic element do not require any more PCB area than the various embodiments without a parasitic element.

While embodiments of the off-board antenna discussed herein are described in connection with automated medicament delivery systems and devices, such an off-board antenna may also be utilized within other devices optionally with modifications that would be apparent to a person having ordinary skill in the art, such as analyte sensors or monitors, without limitation.

Non-limiting illustrative embodiments of this disclosure may include:

Embodiment 1: An automated medicament delivery device for automated administration of medicament to a user-body, the automated medicament delivery device comprising: a delivery system configured to deliver medicament to the user-body; a chassis configured to support one or more components of the delivery system; a housing configured to enclose multiple components therein; a printed circuit board (PCB) within the housing, the PCB comprising a PCB connection; and an off-board antenna comprising: an elevation portion generally extending in a direction transverse to a plane defined by a surface of the PCB, the elevation portion including a connection end electrically connecting the off-board antenna to the PCB; and an upper portion c distal to the connection end and secured to at least one support element chosen from among the chassis and the housing.

Embodiment 2: The automated medicament delivery device according to Embodiment 1, wherein the connection end includes a spring finger connector positioned under a body of the chassis, the body of the chassis configured to maintain consistent contact between the connection end and the PCB connection.

Embodiment 3: The automated medicament delivery device according to any of Embodiments 1 and 2, wherein the PCB connection comprises a blade and tulip connector.

Embodiment 4: The automated medicament delivery device according to any of Embodiments 1-3, wherein the blade and tulip connector includes fingers configured to receive the connection end and the connection end includes a blade-like shape.

Embodiment 5: The automated medicament delivery device according to any of Embodiments 1-4, wherein the connection end includes windings that electrically connects the off-board antenna to the PCB connection.

Embodiment 6: The automated medicament delivery device according to any of Embodiments 1-5, wherein the windings comprise coils and the windings are configured to compress with substantially all of the coils in contact with adjacent coils while in an assembled state.

Embodiment 7: The automated medicament delivery device according to any of Embodiments 1-6, wherein about a full length of each of the majority of the coils is in contact with the adjacent coils.

Embodiment 8: The automated medicament delivery device according to any of Embodiments 1-7, wherein the off-board antenna comprises a monopole.

Embodiment 9: The automated medicament delivery device according to any of Embodiments 1-8, wherein the off-board antenna comprises a primary antenna and a parasitic element, the primary antenna comprising the connection end, the elevation portion, and the upper portion, and the parasitic element physically separated from the primary antenna and the PCB.

Embodiment 10: The automated medicament delivery device according to Embodiment 9, wherein the parasitic element is configured to couple electromagnetically to the primary antenna.

Embodiment 11: The automated medicament delivery device according to any of Embodiments 9-10, wherein the upper portion generally extends from the elevation portion transverse to the elevation portion, offset from the PCB, and the parasitic element includes a segment positioned substantially parallel to, next to, and contactless from the upper portion.

Embodiment 12: The automated medicament delivery device according to any of Embodiments 9-11, wherein a total length of the parasitic element is substantially similar to a total length of the primary antenna including a length of the windings while in a compressed and installed condition.

Embodiment 13: The automated medicament delivery device according to any of Embodiments 9-11, wherein a total length of the parasitic element is significantly different than a total length of the primary antenna including a length of the windings while in a compressed and installed condition.

Embodiment 14: The automated medicament delivery device according to any of Embodiments 1-13, wherein the housing includes a post configured to compress the windings.

Embodiment 15: The automated medicament delivery device according to Embodiment 14, wherein the post includes a rod extending at least partially into the windings to align the antenna with the PCB, and a compression portion configured to compress coils of the windings into the PCB.

Embodiment 16: The automated medicament delivery device according to Embodiment 15, wherein an inner diameter of the windings and an outer surface of the rod are sized to form an interference fit between the windings and the rod.

Embodiment 17: The automated medicament delivery device according to Embodiment 16, wherein the windings include a tapered portion at the connection end.

Embodiment 18: The automated medicament delivery device according to any of Embodiments 1-17, wherein the off-board antenna comprises a singularly formed piece of sheet metal that is bent to define the connection end, the elevation portion, and the upper portion.

Embodiment 19: The automated medicament delivery device according to any of Embodiments 1-18, further comprising at least one electrical contact electrically connecting the PCB to one or more components positioned within the housing, the one or more components configured to function as an antenna while electrically connected to the PCB.

Embodiment 20: The automated medicament delivery device according to any of Embodiments 1-19, further comprising standoffs securing the upper portion to the housing.

Embodiment 21: The automated medicament delivery device according to Embodiment 20, wherein the standoffs are integrally formed with the upper portion.

Embodiment 22: The automated medicament delivery device according to any of Embodiments 20-21, wherein the standoffs comprise heat stakes.

Embodiment 23: The automated medicament delivery device according to any of Embodiments 1-22, wherein the upper portion generally extends from the elevation portion transverse to the elevation portion, offset from the PCB.

Embodiment 24: An automated medicament delivery device for automated administration of medicament to a user-body, the automated medicament delivery device comprising: a delivery system configured to deliver medicament to the user-body; a chassis configured to support one or more components of the delivery system; a printed circuit board (PCB) within a housing, the PCB comprising a PCB connection; and an off-board antenna comprising: an elevation portion generally extending in a direction transverse to a plane defined by a surface of the PCB; an upper portion connected to the elevation portion generally extending transverse to the elevation portion and offset from the PCB, the upper portion secured to the chassis; and a connection end at an end of the elevation portion distal to the upper portion, the connection end electrically connecting the off-board antenna to the PCB.

Embodiment 25: The automated medicament delivery device according to Embodiment 24, wherein the connection end includes a spring finger connector positioned under a body of the chassis, the body of the chassis configured to maintain consistent contact between the connection end and the PCB connection.

Embodiment 26: The automated medicament delivery device according to any of Embodiments 24 and 25, wherein the off-board antenna comprises a singularly formed piece of sheet metal that is bent to define the connection end, the elevation portion, and the upper portion.

Embodiment 27: The automated medicament delivery device according to any of Embodiments 24-26, wherein the chassis includes a body and one or more posts extending from the body, and wherein the off-board antenna defines one or more post openings configured to receive a respective post of the one or more posts.

Embodiment 28: The automated medicament delivery device according to any of Embodiments 24-27, wherein the upper portion includes one or more steps configured to align sections of the upper portion with corresponding sections of a top portion of the chassis.

Embodiment 29: The automated medicament delivery device according to any of Embodiments 24-28, wherein a length a section of the upper portion furthest from the PCB is longer than other sections of the upper portion.

Embodiment 30: An automated medicament delivery device for automated administration of medicament to a user-body, the automated medicament delivery device comprising: a housing configured to enclose multiple components therein; a printed circuit board (PCB) within the housing, the PCB comprising a PCB connection; and an off-board antenna comprising: an elevation portion generally extending in a direction transverse to a plane defined by a surface of the PCB; an upper portion connected to the elevation portion generally extending transverse to the elevation portion and offset from the PCB, the upper portion secured to the housing; and a connection end at an end of the elevation portion distal to the upper portion, the connection end electrically connecting the off-board antenna to the PCB.

Embodiment 31: The automated medicament delivery device according to Embodiment 30, wherein the PCB connection comprises a blade and tulip connector.

Embodiment 32: The automated medicament delivery device according to any of Embodiments 30 and 31, wherein the blade and tulip connector includes fingers configured to receive the connection end and the connection end includes a blade-like shape.

Embodiment 33: The automated medicament delivery device according to any of Embodiments 30-32, wherein the off-board antenna comprises a singularly formed piece of sheet metal that is bent to define the connection end, the elevation portion, and the upper portion.

Embodiment 34: The automated medicament delivery device according to any of Embodiments 30-33, further comprising standoffs securing the upper portion to the housing.

Embodiment 35: The automated medicament delivery device according to any of Embodiments 30-34, wherein the standoffs are integrally formed with the upper portion.

Embodiment 36: The automated medicament delivery device according to any of Embodiments 30-35, wherein the standoffs comprise heat stakes.

Embodiment 37: The automated medicament delivery device according to any of Embodiments 30-36, wherein the standoffs comprise adhesives.

Embodiment 38: An automated medicament delivery device for automated administration of medicament to a user-body, the automated medicament delivery device comprising: a delivery system configured to deliver medicament to the user-body; a printed circuit board (PCB) comprising a PCB connection; and an off-board antenna comprising: an elevation portion generally extending in a direction transverse to a plane defined by a surface of the PCB; and a connection end at an end of the elevation portion, the connection end including windings that electrically connects the off-board antenna to the PCB connection connecting the off-board antenna to the PCB.

Embodiment 39: The automated medicament delivery device according to Embodiment 38, wherein the windings comprise coils and the windings are configured to compress with substantially all of the coils in contact with adjacent coils while in an assembled state.

Embodiment 40: The automated medicament delivery device according to any of Embodiments 38 and 39, wherein about a full length of each of the majority of the coils is in contact with the adjacent coils.

Embodiment 41: The automated medicament delivery device according to any of Embodiments 38-40, wherein the off-board antenna comprises a monopole.

Embodiment 42: The automated medicament delivery device according to any of Embodiment 38-41, wherein the off-board antenna comprises a primary antenna and a parasitic element, the primary antenna comprising the connection end and the elevation portion, and the parasitic element physically separated from the primary antenna and the PCB.

Embodiment 43: The automated medicament delivery device according to Embodiment 42, wherein the parasitic element is configured to couple electromagnetically to the primary antenna.

Embodiment 44: The automated medicament delivery device according to any of Embodiments 42 and 43, the primary antenna includes an upper portion generally extending from the elevation portion transverse to the elevation portion and offset from the PCB, and wherein the parasitic element includes a segment positioned substantially parallel to, next to, and contactless from the upper portion.

Embodiment 45: The automated medicament delivery device according to any of Embodiments 42-44, wherein a total length of the parasitic element is substantially similar to a total length of the primary antenna including a length of the windings while in a compressed and installed condition.

Embodiment 46: The automated medicament delivery device according to any of Embodiments 42-44, wherein a total length of the parasitic element is significantly different than a total length of the primary antenna including a length of the windings while in a compressed and installed condition.

Embodiment 47: The automated medicament delivery device according to any of Embodiments 40-46, wherein a housing includes a post configured to compress the windings and align the antenna with the PCB.

Embodiment 48: The automated medicament delivery device according to any of Embodiments 38-47, wherein a portion of the off-board antenna is secured to at least one support element chosen from a chassis and a housing.

Embodiment 49: An off-board antenna for an automated medicament delivery device for automated administration of medicament to a user-body, the off-board antenna comprising: an elevation portion generally extending in a first direction; and a connection end at an end of the elevation portion and including windings configured to electrically connect to a printed circuit board (PCB) connection of a PCB.

Embodiment 50: The off-board antenna according to Embodiment 49, wherein the windings comprise coils and the windings are configured to compress with substantially all of the coils in contact with adjacent coils while in an assembled state within the automated medicament delivery device.

Embodiment 51: The off-board antenna according to any of Embodiments 49 and 50, wherein about a full length of each of the majority of the coils is in contact with the adjacent coils.

Embodiment 52: The off-board antenna according to any of Embodiments 49-51, wherein the off-board antenna comprises a primary antenna, the primary antenna comprising the connection end and the elevation portion.

Embodiment 53: The off-board antenna according to Embodiment 52, wherein the primary antenna comprises a monopole.

Embodiment 54: The off-board antenna according to any of Embodiments 52 and 53, further comprising a parasitic element configured to be physically separated from the primary antenna while in an assembled state within the automated medicament delivery device.

Embodiment 55: The off-board antenna according to any of Embodiments 52-54, wherein the parasitic element is configured to couple electromagnetically to the primary antenna.

Embodiment 56: The off-board antenna according to any of Embodiments 52-55, wherein the primary antenna includes an upper portion generally extending from the elevation portion transverse to the elevation portion and offset from the PCB, and wherein the parasitic element includes a segment configured to be positioned substantially parallel to, next to, and contactless from the upper portion while in the assembled state within the automated medicament delivery device.

Embodiment 57: The off-board antenna according to any of Embodiments 52-56, wherein a total length of the parasitic element is substantially similar to a total length of the primary antenna including a length of the windings while in a compressed and installed condition.

Embodiment 58: The off-board antenna according to any of Embodiments 49-56, wherein the primary antenna includes an upper portion generally extending from the elevation portion transverse to the elevation portion and offset from the PCB.

Embodiment 59: An automated medicament delivery device for automated administration of medicament to a user-body, the automated medicament delivery device comprising: a delivery system configured to deliver medicament to the user-body; a printed circuit board (PCB), the PCB comprising a PCB connection; a housing enclosing the PCB and the delivery system therein, the housing including a cap and a post, the post including a compression portion extending from the cap and a rod extending from the compression portion; and an off-board antenna comprising: an elevation portion generally extending in a direction transverse to a plane defined by a surface of the PCB; an upper portion connected to the elevation portion generally extending transverse to the elevation portion and offset from the PCB, the upper portion secured to the chassis; and a connection end at an end of the elevation portion distal to the upper portion, the connection end including windings with the rod inserted at least partially therein, the windings compressed between the compression portion and the PCB connection and electrically connecting the off-board antenna to the PCB.

Embodiment 60: The off-board antenna according to Embodiment 59, wherein an inner diameter of the windings and an outer surface of the rod are sized to form an interference fit between the windings and the rod.

Embodiment 61: The off-board antenna according to any of Embodiments 59 and 60, wherein the housing includes a heat sink extending from the cap, and wherein a part of the upper portion is connected to the heat sink.

The embodiments described above and illustrated in the accompanying drawings do not limit the scope of the disclosure, which is encompassed by the scope of the appended claims and their legal equivalents. Any equivalent embodiments are within the scope of this disclosure. Indeed, various modifications, in addition to those shown and described herein, such as alternate useful combinations of the elements described, will become apparent to those skilled in the art from the description. Such modifications and embodiments also fall within the scope of the appended claims and equivalents.

What is claimed is:

1. An automated medicament delivery device for automated administration of medicament to a user-body, the automated medicament delivery device comprising:
a delivery system configured to deliver medicament to the user-body;
a chassis configured to support one or more components of the delivery system;
a housing configured to enclose multiple components therein;
a printed circuit board (PCB) within the housing, the PCB comprising a PCB connection; and
an off-board antenna comprising:
an elevation portion generally extending in a direction transverse to a plane defined by a surface of the PCB, the elevation portion including a connection end electrically connecting the off-board antenna to the PCB; and
an upper portion distal to the connection end and secured to at least one support element chosen from among the chassis and the housing.

2. The automated medicament delivery device of claim 1, wherein the connection end includes windings that electrically connects the off-board antenna to the PCB connection.

3. The automated medicament delivery device of claim 2, wherein the windings comprise coils and the windings are configured to compress with substantially all of the coils in contact with adjacent coils while in an assembled state.

4. The automated medicament delivery device of claim 3, wherein about a full length of each of the majority of the coils is in contact with the adjacent coils.

5. The automated medicament delivery device of claim 2, wherein the off-board antenna comprises a monopole.

6. The automated medicament delivery device of claim 5, wherein the off-board antenna comprises a primary antenna and a parasitic element, the primary antenna comprising the connection end, the elevation portion, and the upper portion, and the parasitic element physically separated from the primary antenna and the PCB.

7. The automated medicament delivery device of claim 6, wherein the parasitic element is configured to couple electromagnetically to the primary antenna.

8. The automated medicament delivery device of claim 6, wherein the upper portion generally extends from the elevation portion transverse to the elevation portion, offset from the PCB, and the parasitic element includes a segment positioned substantially parallel to, next to, and contactless from the upper portion.

9. The automated medicament delivery device of claim 6, wherein a total length of the parasitic element is substantially similar to a total length of the primary antenna including a length of the windings while in a compressed and installed condition.

10. The automated medicament delivery device of claim 2, wherein the housing includes a post configured to compress the windings.

11. The automated medicament delivery device of claim 10, wherein the post includes a rod extending at least partially into the windings to align the antenna with the PCB, and a compression portion configured to compress coils of the windings into the PCB.

12. The automated medicament delivery device of claim 11, wherein an inner diameter of the windings and an outer surface of the rod are sized to form an interference fit between the windings and the rod.

13. The automated medicament delivery device of claim 2, wherein the windings include a tapered portion at the connection end.

14. The automated medicament delivery device of claim 1, further comprising standoffs securing the upper portion to the housing.

15. The automated medicament delivery device of claim 14, wherein the standoffs are integrally formed with the upper portion.

16. The automated medicament delivery device of claim 14, wherein the standoffs comprise heat stakes.

17. An automated medicament delivery device for automated administration of medicament to a user-body, the automated medicament delivery device comprising:
a delivery system configured to deliver medicament to the user-body;
a printed circuit board (PCB), the PCB comprising a PCB connection;
a housing enclosing the PCB and the delivery system therein, the housing including a cap and a post, the post including a compression portion extending from the cap and a rod extending from the compression portion; and
an off-board antenna comprising:
an elevation portion generally extending in a direction transverse to a plane defined by a surface of the PCB;
an upper portion connected to the elevation portion generally extending transverse to the elevation portion and offset from the PCB, the upper portion secured to the chassis; and
a connection end at an end of the elevation portion distal to the upper portion, the connection end including windings with the rod inserted at least partially therein, the windings compressed between the compression portion and the PCB connection and electrically connecting the off-board antenna to the PCB.

18. The automated medicament delivery device of claim 17, wherein an inner diameter of the windings and an outer surface of the rod are sized to form an interference fit between the windings and the rod.

19. The automated medicament delivery device of claim 17, wherein the housing includes a heat sink extending from the cap, and wherein a part of the upper portion is connected to the heat sink.

20. An off-board antenna for an automated medicament delivery device for automated administration of medicament to a user-body, the off-board antenna comprising:
an elevation portion generally extending in a first direction; and
a connection end at an end of the elevation portion and including windings configured to electrically connect to a printed circuit board (PCB) connection of a PCB.
